(19) United States
(12) Patent Application Publication
(10) Pub. No.: US 2011/0234347 A1
(43) Pub. Date: Sep. 29, 2011

(54) POLE PIECE FOR PERMANENT MAGNET MRI SYSTEMS

(75) Inventor: Uri RAPOPORT, Moshav Ben Shemen (IL)

(73) Assignee: ASPECT MAGNET TECHNOLOGIES LTD., Shoham (IL)

(21) Appl. No.: 13/049,119

(22) Filed: Mar. 16, 2011

Related U.S. Application Data
(60) Provisional application No. 61/316,853, filed on Mar. 24, 2010.

(51) Int. Cl. H01F 7/02; B23P 17/04

(52) U.S. Cl. 335/302; 29/428

(57) ABSTRACT

A pole piece for a permanent magnet MRI system and a method for increasing the stability of a gradient field in an MRI system. The method includes: obtaining an MRI system comprising a magnet capable of providing a gradient magnetic field within an image volume in an air gap; and fixing a plurality of pole pieces within said MRI system, thereby defining the air gap, the raw material of construction of the pole piece being a material including a plurality of ferromagnetic particles coated with an electrically insulating substance. The fixing increases the stability of said gradient field by at least 10% relative to that of a gradient magnetic field in an MRI system identical except for the use of the material in the fabrication of the pole pieces.

### FIELD OF THE INVENTION

This invention relates to improved pole pieces for permanent magnet MRI systems, in particular, pole pieces that are manufactured from materials that enable them to provide more stable gradient magnetic fields.

### BACKGROUND OF THE INVENTION

One well-known problem in permanent magnet MRI systems is the limitations on the stability of the gradient fields that result from eddy currents in, and residual magnetization of, the pole pieces. Eddy currents are created when a rapidly changing magnetic field is applied to the pole faces, and these eddy currents created magnetic fields that oppose the applied magnetic field. Due to the hysteresis of ferromagnetic materials, application of a time-dependent magnetic field also creates a secondary residual magnetic field that remains even after the applied external field is removed. The magnetic fields caused by eddy currents and residual magnetization distort the applied magnetic field of the MRI device itself, reducing the resolution of the image created therein.

One solution to this problem that has been proposed has been the use of high-permeability, high-resistance ferromagnetic materials in the construction of the pole pieces. For example, U.S. Pat. No. 5,061,987 discloses the use of a layer of a material such as ferrite with a maximum permeability of greater than 1000 and a resistivity of greater than 10⁻³ ohm-cm for preventing production of eddy currents while the gradient field is being produced. A similar system was disclosed in U.S. Pat. No. 5,592,089, wherein the layer of high-permeability material is placed on the surface of the magnet that faces the gap in which the object to be imaged is placed.

Examples of MRI assemblies in which the pole pieces are themselves constructed from high-permeability material are also known in the art. For example, U.S. Pat. No. 5,631,616 discloses a magnetic field generating device for use in MRI in which the pole pieces have a laminate structure in which a soft ferrite and a magnetic material base are disposed from the side of the gap between the magnets and a layer of small magnetic permeability material is interposed between the soft ferrite and the magnetic material base. U.S. Pat. No. 5,680,086 discloses an MRI magnet in which the pole pieces are fabricated from wound high permeability soft magnetic material. The wound material can be a radially laminated winding or a series of concentric rings. U.S. Pat. No. 6,150,818 discloses MRI pole faces constructed from a number of blocks of amorphous material having laminate sheets.

More recently, it has been demonstrated (e.g. in the disclosure of U.S. Pat. No. 7,319,326) that it is possible to obtain a useful level of damping of eddy currents and residual magnetization with materials of lower permeability than had previously been thought necessary, and that a maximum permeability of on the order of 100 may be sufficient to provide enhanced gradient stability.

In all of the systems known in the art, however, the pole pieces constructed of high-permeability ferromagnetic material are themselves constructed from a plurality of components, which makes construction of such pole pieces complicated and impractical. In particular, these systems tend to comprise layers of a high-permeability material such as electrical steel over the pole piece itself. In addition to the impracticality of the additional material, the placement of additional layers of material over the magnet pole face, as is typical of these systems, requires that the magnets be placed further apart in order to maintain the same sample volume. In order to achieve the same magnetic field, the size of the magnet will need to increase in proportion to the cube of the distance between the pole faces. Not only does this required increase in the size of the magnets make them more unwieldy and less convenient to work with, but also increases the amounts (and concomitant costs) of ancillary items such as electricity and cooling needed to run the system.

The use of shielding materials to overcome the problems of eddy currents and residual magnetization suffers from the additional disadvantage that the shield creates a magnetic field opposite to that created by the primary gradient coil, reducing the gradient efficiency typically by 30-50% relative to a non-shielded gradient.

Thus, there remains a long-felt need for pole pieces for a permanent magnet MRI system in which the pole pieces are constructed of a material that will limit eddy currents and residual magnetization on the one hand but in which each pole piece is manufactured as a single unit.

### SUMMARY OF THE INVENTION

The invention herein disclosed is designed to meet this long-felt need. Pole pieces in an MRI system are constructed from a soft ferromagnetic composite material that comprises particles of ferromagnetic material each of which is coated with an electrically insulating substance. Not only do these materials both have the desired magnetic properties, they are relatively easily worked and can be fabricated into a magnet comprising a single unit of any desired configuration. Indeed, magnets made from such materials are known in the art and are used, for example, as stators in DC motors.

It is thus an object of the present invention to disclose a pole piece for a permanent magnet MRI system, wherein the raw material of construction of said pole piece is a material comprising a plurality of ferromagnetic particles coated with an electrically insulating substance.

It is a further object of this invention to disclose such a pole piece, wherein said pole piece is substantially parallelepiped shaped.

It is a further object of this invention to disclose such a pole piece, wherein said material comprising a plurality of ferromagnetic particles comprises substantially pure iron.

It is a further object of this invention to disclose such a pole piece, wherein said ferromagnetic particles have a maximum dimension of less than about 0.1 mm.

It is a further object of this invention to disclose such a pole piece, wherein said material comprising a plurality of ferromagnetic particles is characterized by at least one characteristic chosen from the group consisting of (a) maximum relative magnetic permeability of about 205; (b) maximum differential magnetic permeability of about 280; (c) initial permeability at 60 mT of about 130; (d) saturation magnetization at 16 kA/m of about 1.5 T; (e) coercive force of about 380 A/m; and (f) absolute energy loss of one cycle of about 2100 J/m³.

It is a further object of this invention to disclose such a pole piece, wherein said material comprising a plurality of ferromagnetic particles is characterized by a resistivity of at least 0.009 ohm-m.

It is a further object of this invention to disclose such a pole piece, wherein the eddy current decay constant within said pole piece is less than about 50 μs when said pole piece is exposed to an external magnetic field of 1 T.

It is a further object of this invention to disclose such a pole piece, wherein the residual magnetization of said pole piece is about 0.1%.

It is a further object of this invention to disclose an MRI magnet providing a gradient magnetic field within an image volume in an air gap, said air gap defined by a plurality of pole pieces, wherein the raw material of construction of at least one of said plurality of pole pieces is a material comprising a plurality of ferromagnetic particles coated with an electrically insulating substance.

It is a further object of this invention to disclose such an MRI magnet, wherein said pole pieces are substantially parallelepiped shaped.

It is a further object of this invention to disclose such an MRI magnet, wherein said material comprising a plurality of ferromagnetic particles comprises substantially pure iron.

It is a further object of this invention to disclose such an MRI magnet, wherein said ferromagnetic particles have a maximum dimension of less than about 0.1 mm.

It is a further object of this invention to disclose such an MRI magnet, wherein said material comprising a plurality of ferromagnetic particles is characterized by at least one characteristic chosen from the group consisting of (a) maximum relative magnetic permeability of about 205; (b) maximum differential magnetic permeability of about 280; (c) initial permeability at 60 mT of about 130; (d) saturation magnetization at 16 kA/m of about 1.5 T; (e) coercive force of about 380 A/m; and (f) absolute energy loss of one cycle of about 2100 J/m³.

It is a further object of this invention to disclose such an MRI magnet, wherein said material comprising a plurality of ferromagnetic particles is characterized by a resistivity of at least 0.009 ohm-m.

It is a further object of this invention to disclose such an MRI magnet, wherein the eddy current decay constant within said pole pieces is less than about 50 μs when said pole piece is exposed to an external magnetic field of 1 T.

It is a further object of this invention to disclose such an MRI magnet, wherein the residual magnetization of each of said pole pieces is about 0.1%.

It is a further object of this invention to disclose such an MRI magnet, wherein said gradient magnetic field is substantially free of B₀ and x² components.

It is a further object of this invention to disclose such an MRI magnet, wherein the gradient efficiency is about 3 times greater than in an MRI magnet otherwise identical except for the use of shielded pole pieces in place of pole pieces constructed from said material comprising a plurality of ferromagnetic particles coated with an electrically insulating substance.

It is a further object of this invention to disclose a method for increasing the stability of a gradient field in an MRI system, said method comprising steps of (a) obtaining an MRI system comprising a magnet capable of providing a gradient magnetic field within an image volume in an air gap; and (b) fixing a plurality of pole pieces within said MRI system, thereby defining said air gap, the raw material of construction of said pole piece being a material comprising a plurality of ferromagnetic particles coated with an electrically insulating substance. It is within the essence of the invention wherein said step of fixing said pole pieces within said MRI system increases the stability of said gradient field by at least 10% relative to that of a gradient magnetic field in an MRI system identical except for the use of said material in the fabrication of said pole pieces.

### DETAILED DESCRIPTION OF THE PREFERRED EMBODIMENTS

As used herein, the term “MRI” (magnetic resonance imaging) refers to an instrument designed to measure the nuclear magnetic resonance signals obtained from a sample placed within a defined sample volume, in particular, such a system designed for imaging. The term is intended, however, to include any NMR apparatus that can include the pole pieces disclosed herein.

The pole piece disclosed in the present invention is made from a material comprising ferromagnetic particles coated with an electrically insulating substance. In a preferred embodiment, the ferromagnetic material of which the particles are composed is substantially pure iron, and the particle size is less than about 0.1 mm. Such materials are commercially available and are sold under such trade names as PERMEDYN and SOMALOY. As a non-limiting example of the electromagnetic properties of these materials, PERMEDYN MF-2 has a maximum permeability of >200, a maximum differential magnetic permeability of 280, an initial permeability at 60 mT of 130, coercive force of 4.78 Oe, a saturation magnetization of 1.5 T, saturation magnetization at 16 kA/m of about 1.5 T, coercive force of about 380 A/m, absolute energy loss of one cycle of about 2100 J/m³, and a resistivity of 0.95 ohm-cm.

The pole is fabricated as a single unit in any desired shape or configuration by methods well-known in the art for forming objects from soft ferromagnetic particulate materials such as high-pressure molding. In a preferred embodiment of the invention, the pole piece is shaped substantially as a parallelepiped. A pole piece manufactured in this fashion from a material with the above properties will have a very short eddy current decay time constant (typically 50 μs or less in a 1 T magnetic field) and very narrow hysteresis in an external magnetic field. When the eddy current decay is this rapid, eddy currents will not affect the NMR signal or image quality. If necessary, compensation for any residual effects of eddy currents can be made by pre-emphasis of the desired signal to the gradient power supply. For most amplifiers, this correction is of the same order of magnitude as the corrections used for amplifier calibration.

In addition to the short eddy current decay time constant, the pole pieces disclosed in the present invention have very low residual magnetization, typically about 0.1%. The pole piece material remains in the linear part of the B-H curve while it is exposed to the external magnetic field and to the gradient field, and it is made of a material with a high effective permeability. As a result, the symmetry of the gradient field in an MRI instrument that comprises these pole pieces is retained and therefore has no B₀ or x² component.

It is also within the scope of the present invention to disclose an MRI magnet comprising a plurality of pole pieces constructed as described above. The MRI magnet is adapted to produce a gradient magnetic field within an image volume in an air gap according to any of the methods well known in the art. Pole pieces of the type described above define the sample define the air gap. Given the properties of the materials from which the pole pieces are made, as discussed in detail above, the gradient magnetic field will have essentially no B₀ of or x² component. The gradient efficiency in such an MRI magnet is typically 160-190% of that of a gradient designed for free space, and typically 3 times greater than that of the shielded gradients known in the art. Since the gradient efficiency is so much higher in the MRI magnet herein disclosed than in those known in the art, a system that comprises an MRI magnet as disclosed in the current invention will be able to use a gradient power supply that provides lower current than those known in the art, and will also have substantially less stringent cooling demands.

It is also within the scope of the invention to disclose a method for increasing the stability of a gradient field in an MRI system. When a plurality of pole pieces as disclosed above are used in an MRI system to define the air gap within which the image volume is located, the properties of the pole pieces as described in detail above provide gradient fields that are at least 10% more stable than those of similar MRI systems that comprise pole pieces made according to methods known in the prior art.

### EXAMPLE

As described in detail above, the low residual magnetization of the material from which the pole pieces herein disclosed along with the use of the pole pieces under the conditions listed above, namely, use within the linear portion of the B-H curve and use of a high-permeability material, enables the system to maintain the symmetry of the gradient field. Thus, it is possible to calculate the gradient field making use of the symmetry of the situation and image currents.

Because there are two parallel pole pieces, there are an infinite number of images (analogous to two parallel mirrors). As a first approximation, it is possible to perform the calculation using the first mirror image.

Given a pole piece located at a distance D from the center of the field of view and at a distance D/a from the pole piece to the gradient coil, the image current will be located at a distance of D/a from the pole piece, but in the direction opposite to that of the gradient coil. The distance from the gradient coil to the center of the field of will be D(1−1/a) and the distance from the gradient coil to the image current will be D(1+1/a). Since the magnetic field is proportional to R⁻² where R is the distance from the source current to the point at which the magnetic field is calculated, the contribution from the image current will just be the square of the ratio of the distances from the source current and the image current to the gradient coil, i.e. (1−1/a)²/(1+1/a)². In the case that a=10, the contribution from the image current will be 0.67 relative to the magnetic field in air. Thus, the use of the pole pieces herein disclosed will increase the magnetic field B by 67% relative to the magnetic field in air. Note that higher-order approximations will increase this value further.

We claim:

1. A pole piece for a permanent magnet MRI system, wherein the raw material of construction of said pole piece is a material comprising a plurality of ferromagnetic particles coated with an electrically insulating substance.

2. The pole piece of claim 1, wherein said pole piece is substantially parallelepiped shaped.

3. The pole piece of claim 1, wherein said material comprising a plurality of ferromagnetic particles comprises substantially pure iron.

4. The pole piece of claim 1, wherein said ferromagnetic particles have a maximum dimension of less than about 0.1 mm.

5. The pole piece of claim 1, wherein said material comprising a plurality of ferromagnetic particles is characterized by at least one characteristic chosen from the group consisting of (a) maximum relative magnetic permeability of about 205; (b) maximum differential magnetic permeability of about 280; (c) initial permeability at 60 mT of about 130; (d) saturation magnetization at 16 kA/m of about 1.5 T; (e) coercive force of about 380 A/m; and (f) absolute energy loss of one cycle of about 2100 J/m³.

6. The pole piece of claim 1, wherein said material comprising a plurality of ferromagnetic particles is characterized by a resistivity of at least 0.009 ohm-m.

7. The pole piece of claim 1, wherein the eddy current decay constant is less than about 50 μs when said pole piece is exposed to an external magnetic field of 1 T.

8. The pole piece of claim 1, wherein the residual magnetization of said pole piece is about 0.1%.

9. An MRI magnet providing a gradient magnetic field within an image volume in an air gap, said air gap defined by a plurality of pole pieces, wherein the raw material of construction of at least one of said plurality of pole pieces is a material comprising a plurality of ferromagnetic particles coated with an electrically insulating substance.

10. The MRI magnet of claim 9, wherein said pole pieces are substantially parallelepiped shaped.

11. The MRI magnet of claim 9, wherein said material comprising a plurality of ferromagnetic particles comprises substantially pure iron.

12. The MRI magnet of claim 9, wherein said ferromagnetic particles have a maximum dimension of less than about 0.1 mm.

13. The MRI magnet of claim 9, wherein said material comprising a plurality of ferromagnetic particles is characterized by at least one characteristic chosen from the group consisting of (a) maximum relative magnetic permeability of about 205; (b) maximum differential magnetic permeability of about 280; (c) initial permeability at 60 mT of about 130; (d) saturation magnetization at 16 kA/m of about 1.5 T; (e) coercive force of about 380 A/m; and (f) absolute energy loss of one cycle of about 2100 J/m³.

14. The MRI magnet of claim 9, wherein said material comprising a plurality of ferromagnetic particles is characterized by a resistivity of at least 0.009 ohm-m.

15. The MRI magnet of claim 9, wherein the eddy current decay constant within said pole pieces is less than about 50 μs when said pole piece is exposed to an external magnetic field of 1 T.

16. The MRI magnet of claim 9, wherein the residual magnetization of each of said pole pieces is about 0.1%.

17. The MRI magnet of claim 9, wherein said gradient magnetic field is substantially free of B₀ and x² components.

18. The MRI magnet of claim 9, wherein the gradient efficiency is about 3 times greater than in an MRI magnet otherwise identical except for the use of shielded pole pieces in place of pole pieces constructed from said material comprising a plurality of ferromagnetic particles coated with an electrically insulating substance.

19. A method for increasing the stability of a gradient field in an MRI system, said method comprising steps of:
a. obtaining an MRI system comprising a magnet capable of providing a gradient magnetic field within an image volume in an air gap; and,
b. fixing a plurality of pole pieces within said MRI system, thereby defining said air gap, the raw material of construction of said pole piece being a material comprising a plurality of ferromagnetic particles coated with an electrically insulating substance;
wherein said step of fixing said pole pieces within said MRI system increases the stability of said gradient field by at least 10% relative to that of a gradient magnetic field in an MRI system identical except for the use of said material in the fabrication of said pole pieces.
